(19) United States
(12) Patent Application Publication
(10) Pub. No.: US 2014/0300011 A1
(43) Pub. Date: Oct. 9, 2014

(54) APPARATUS AND METHOD FOR MANUFACTURING OPTICAL FILM

(71) Applicant: HON HAI PRECISION INDUSTRY CO., LTD., New Taipei (TW)

(72) Inventor: JIA-MING WANG, New Taipei (TW)

(73) Assignee: HON HAI PRECISION INDUSTRY CO., LTD., New Taipei (TW)

(21) Appl. No.: 14/141,438

(22) Filed: Dec. 27, 2013

(30) Foreign Application Priority Data
Apr. 3, 2013 (TW) 102112079

(51) Int. Cl. B29C 59/04; B29D 11/00; B29C 39/16

(52) U.S. Cl. CPC B29C 59/043; B29C 39/16; B29D 11/00788
USPC 264/1.6; 425/224

(57) ABSTRACT

An exemplary apparatus for manufacturing an optical film includes a feed hopper, a platen, a first pressing roller group, and a second pressing roller group. The feed hopper is configured for providing resin. The platen and the first pressing roller group are arranged adjacent to the feeding hopper and spaced a predetermined distance to define a guiding channel. A second pressing roller group is arranged below the first pressing roller group and spaced the predetermined distance thereby defining a molding channel. The melted resin flows into the guiding channel and is pressed by the platen and the first pressing roller group, and is then rolled into the molding channel with rolling of the first pressing roller group. The first and the second pressing roller group are configured for forming microstructures on opposite surfaces of the optical film, respectively. A method for manufacturing the optical film is also provided.

### BACKGROUND

1. Technical Field

The present disclosure relates to an apparatus for manufacturing an optical film, and a method for manufacturing the optical film using the apparatus.

2. Description of Related Art

Optical films are used in backlight modules for guiding light. Opposite surfaces of a typical optical film comprise a number of microstructures. The optical film can be manufactured by a rolling device. The rolling device comprises two pressing rollers with microstructures formed on circumferential surfaces thereof. The pressing rollers are arranged side-by-side, and are driven to press opposite surfaces of an unprocessed optical film to mold the microstructures of the optical film.

However, a molding route of the microstructures of the pressing rollers is relatively short. As a result, the shapes of the microstructures molded on the surfaces of the optical film may not be fully formed. When this happens, a brightness of the backlight module employing the optical film is reduced.

Therefore, it is desirable to provide an apparatus for manufacturing an optical film and a method for manufacturing an optical film using the apparatus to overcome the above-mentioned problems.

### BRIEF DESCRIPTION OF THE DRAWINGS

FIG. 1 is a schematic view of a first embodiment of an apparatus for manufacturing an optical film, showing an optical film being processed.

FIG. 2 is a schematic view of a second embodiment of an apparatus for manufacturing an optical film, showing an optical film being processed.

FIG. 3 is a schematic view of a third embodiment of an apparatus for manufacturing an optical film, showing an optical film being processed.

FIG. 4 is a flowchart of an embodiment of a method for manufacturing an optical film using the apparatus of FIG. 3.

### DETAILED DESCRIPTION

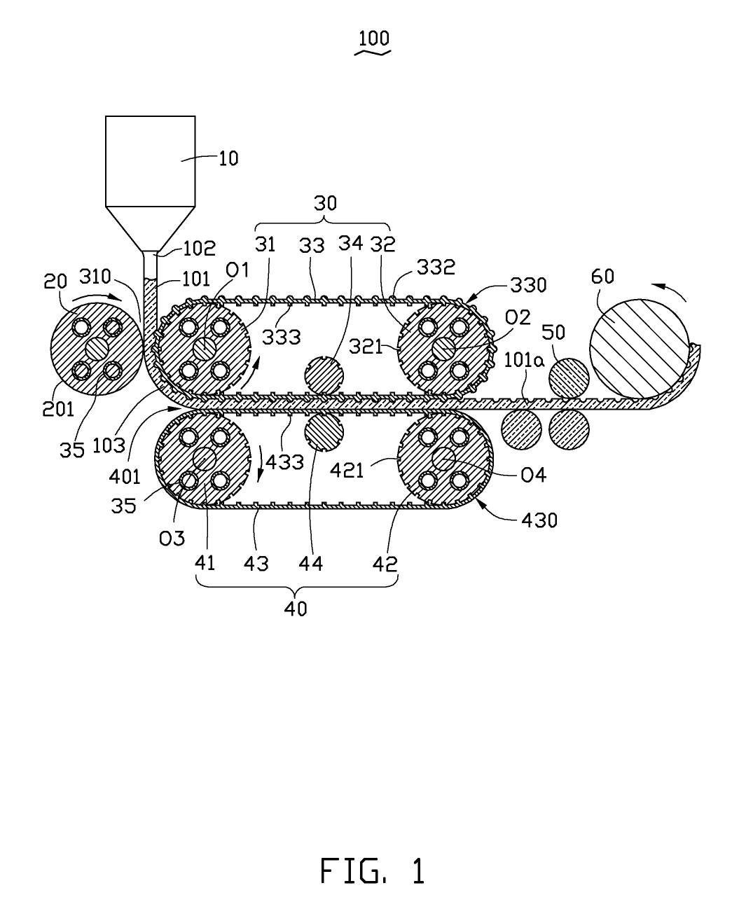

FIG. 1 shows an apparatus 100 for manufacturing an optical film 101a according to a first embodiment. The apparatus 100 comprises a feeder 10, a cylindrical platen 20, a first pressing roller group 30, a second pressing roller group 40, a number of pinch rollers 50, and a winding roller 60. The optical film 101a can be, but is not limited to being, a light guide plate, a diffusion film, a brightness enhancement film, or a prism sheet.

The feeder 10 is substantially funnel-shaped and comprises a pipe 102. The feeder 10 is configured for providing a resin 101 in hot melted form through the pipe 102.

The platen 20 comprises a smooth circumferential surface 201, and a number of cooling pipes 35. The cooling pipes 35 are arranged around a central axis of the platen 20.

The first pressing roller group 30 and the platen 20 are arranged under the feeder 10 and spaced a predetermined distance from each other. A first pressing roller 31 of the first pressing roller group 30 and the platen 20 define a guiding channel 310 therebetween. A width of the guiding channel 310 determines a thickness of the optical film 101a. The first pressing roller group 30 comprises the first pressing roller 31 defining a first central axis O1, a second pressing roller 32 defining a second central axis O2, a first rotating band 33, and a first intermediate roller 34. The first central axis O1 and the second central axis O2 are arranged on a common horizontal plane and are substantially parallel to each other. The first rotating band 33 is wound around the first pressing roller 31 and the second pressing roller 32. The first pressing roller 31 and the second pressing roller 32 cooperatively rotate the first rotating band 33. The first intermediate roller 34 is arranged between the first pressing roller 31 and the second pressing roller 32, and contacts the first rotating band 33. The first intermediate roller 34 has a central axis. As the first rotating band 33 rotates around the first pressing roller 31 and the second pressing roller 32, the first intermediate roller 34 rotates around its central axis. The first intermediate roller 34 is configured for enhancing accurate formation of pressed microstructures on a top surface of the pressed resin 101.

The second pressing roller group 40 is spaced the predetermined distance from the first pressing roller group 30 to form a molding channel 401. The second pressing roller group 40 comprises a third pressing roller 41 defining a third central axis O3, a fourth pressing roller 42 defining a fourth central axis O4, and a second rotating band 43. The third central axis O3 and the fourth central axis O4 are arranged on a common horizontal plane and are substantially parallel to each other. The second rotating band 43 is wound around the third pressing roller 41 and the fourth pressing roller 42. The third pressing roller 41 and the fourth pressing roller 43 cooperatively rotate the second rotating band 43. The first rotating band 33 and the second rotating band 43 are made of metal, but can be made of other suitable material in other embodiments. The second intermediate roller 44 is arranged between the third pressing roller 41 and the fourth pressing roller 42, and contacts the second rotating band 43. The second intermediate roller 44 has a central axis. As the second rotating band 43 rotates around the third pressing roller 41 and the fourth pressing roller 42, the second intermediate roller 44 rotates around its central axis. The second intermediate roller 44 is configured for enhancing accurate formation of the pressed microstructures on the top surface of the pressed resin 101.

The first rotating band 33 comprises a first inner surface (not labeled) and a first outer surface 330. The first inner surface comprises a number of first convex gear structures 333, and the first outer surface 330 comprises a number of first microstructures 332. The first convex gear structures 333 can be in the form of gear teeth. Each of the first microstructures 332 is substantially round. For example, each first microstructure 332 can be a hemisphere, or an elongated bar with a semicircular cross-section. The second rotating band 43 comprises a second inner surface (not labeled) and a second outer surface 430. The second inner surface comprises a number of second convex gear structures 433, and the second outer surface 430 is a smooth surface. The second convex gear structures 433 can be in the form of gear teeth.

Outer circumferential surfaces of the first pressing roller 31 and the second pressing roller 32 define a number of first concave gear structures 321 corresponding to the first convex gear structures 333 of the first rotating band 33. The first concave gear structures 321 can be in the form of gear recesses. Outer circumferential surfaces of the third pressing roller 41 and the fourth pressing roller 42 define a number of second concave gear structures 421 corresponding to the second convex gear structures 433 of the second rotating band 43. The second concave gear structures 421 can be in the form of gear recesses. The concave gear structures 321, 421 and the convex gear structures 333, 433 are configured for preventing the first and second rotating bands 33, 43 from sliding when rotating.

The first pressing roller 31, the second pressing roller 32, the third pressing roller 41, and the fourth pressing roller 42 each comprise a number of the cooling pipes 35, which are arranged around central axes thereof. The cooling pipes 35 receive cooling water for cooling the hot resin 101 and thereby molding the cooled resin 101 into the optical film 101a quickly.

The pinch rollers 50 are arranged adjacent to rear ends of the first pressing roller group 30 and the second pressing roller group 40, and are configured and arranged for adjusting a strain on the optical film 101a. The pinch rollers 50 are used for preventing the optical film 101a from warping. In this embodiment, there are three pinch rollers 50.

The hot melted resin 101 from the feeding hopper 10 flows into the guiding channel 310 and is cooled and pressed by the platen 20 and the first pressing roller group 30. The cooled resin 101 is then rolled into the molding channel 401 with rolling of the first pressing roller group 30. The first pressing roller group 30 and the second pressing roller group 40 cooperatively roll the pressed resin 101 through the molding channel 401. The first pressing roller group 30 presses the first microstructures 332 on the top surface of the pressed resin 101 to form the optical film 101a.

The winding roller 60 is substantially a hollow cylinder, and is configured for winding the optical film 101a. Each pinch roller 50 defines a fifth central axis (not shown) in a central portion thereof. The winding roller 60 defines a sixth central axis (not shown) in a central portion thereof

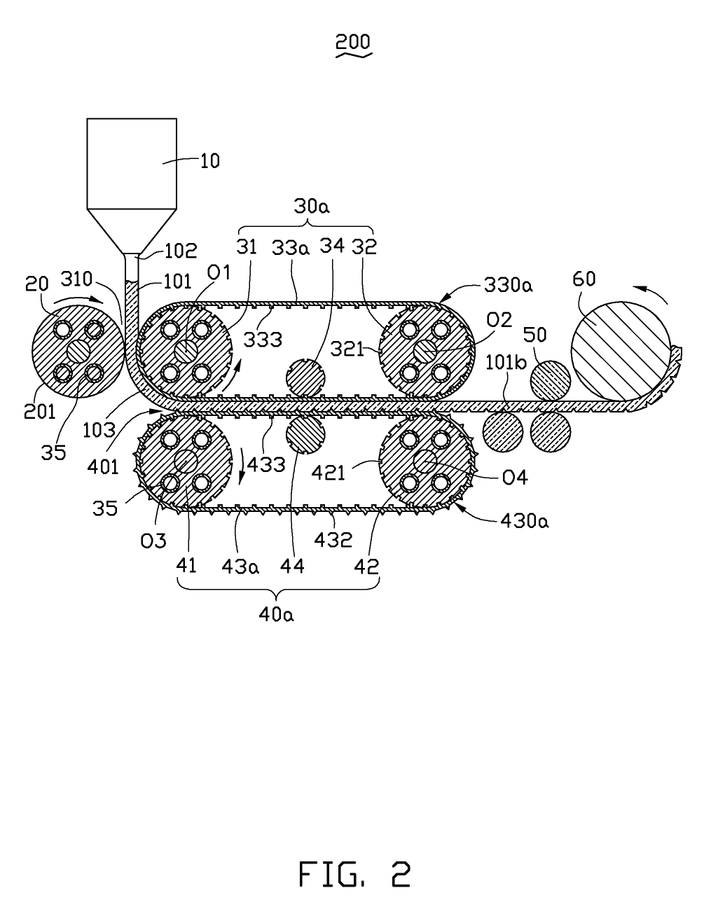

FIG. 2 shows an apparatus 200 for manufacturing an optical film 101b according to a second embodiment. The difference between the apparatus 200 and the apparatus 100 of the first embodiment is that in the apparatus 200, a first outer surface 330a of a first rotating band 33a is a smooth surface and a second outer surface 430a of a second rotating band 43a comprises a number of second microstructures 432. For example, each of the second microstructure 432 can be a pyramid, or an elongated bar with a V-shaped cross-section. As a result, the second outer surface 430a is configured for pressing microstructures on a bottom surface of the pressed resin 101 to form the optical film 101b.

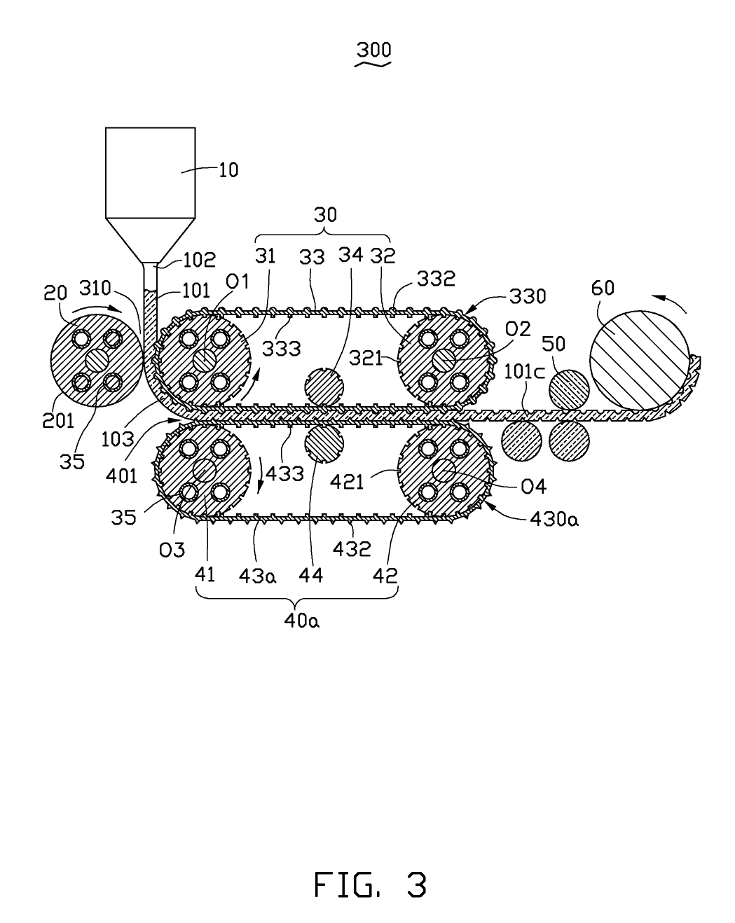

FIG. 3 shows an apparatus 300 for manufacturing an optical film 101c according to a third embodiment. The difference between the apparatus 300 and the apparatus 100 of the first embodiment is that in the apparatus 300, a second outer surface 430a of a second rotating band 43a comprises a number of second microstructures 432. As a result, the first outer surface 330 and the second outer surface 430a are both configured for forming microstructures on the opposite top and bottom surfaces of the pressed resin 101 to form the optical film 101c.

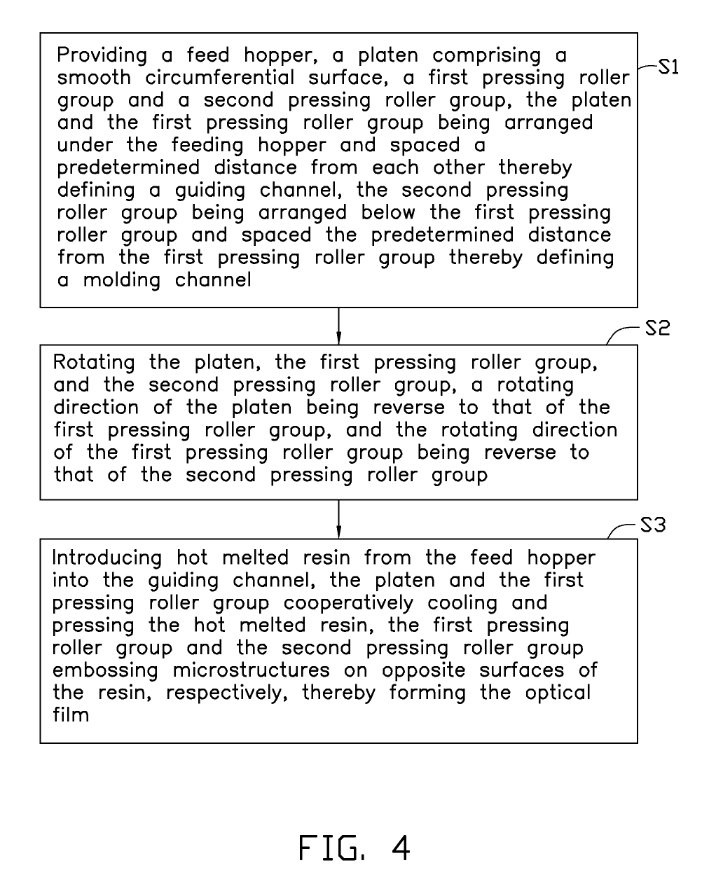

Referring to FIGS. 3-4, a method for manufacturing the optical film 101c is shown and summarized. The method comprises the following steps.

In step S1, the feeder 10, the platen 20, the first pressing roller group 30, and the second pressing roller group 40 are provided.

In step S2, the platen 20, the first pressing roller group 30, and the second pressing roller group 40 are rotated. A rotating direction of the platen 20 is opposite to a rotating direction of the first pressing roller group 30, and the rotating direction of the first pressing roller group 30 is opposite to a rotating direction of the second pressing roller group 40. In this embodiment, the platen 20 and the second pressing roller group 40 rotate clockwise, and the first pressing roller group 30 rotates counterclockwise.

In step S3, the hot melted resin 101 is introduced into the guiding channel 310 and cooled and pressed by the platen 20 and the first pressing roller group 30. The cooled resin 101 is then rolled into the molding channel 401 with rolling of the first pressing roller group 30. Then the cooled resin 101 is rolled through the molding channel 401 cooperatively by the first pressing roller group 30 and a second pressing roller group 40a. The first pressing roller group 30 presses the first microstructures 332 on a first (top) surface of the cooled resin 101, and the second pressing roller group 40a presses the second microstructures 432 on a second (bottom) surface of the cooled resin 101. Thereby, microstructures are formed on the first surface and the second surface of the optical film 101c. Then, the optical film 101c is wound around the winding roller 60. The resin 101 can be made of polystyrene, polymethyl methacrylate, polycarbonate, or UV-curable glue. However, the resin 101 is not limited to being made of these materials.

In summary, the above-described apparatuses and method are used for manufacturing an optical film, including forming microstructures on the optical film. A processing route of the formed microstructures is longer, and the microstructures can be formed on the first and/or second surfaces completely without defects.

It is to be understood, however, that even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An apparatus for manufacturing an optical film, the apparatus comprising:
a feed hopper comprising a pipe, the feed hopper configuring for providing resin in melted form to mold the optical film;
a platen comprising a smooth circumferential surface;
a first pressing roller group, the platen and the first pressing roller group both being arranged under the feeding hopper and spaced a predetermined distance from each other thereby defining a guiding channel between the platen and the first pressing roller group, the first pressing roller group comprising a first pressing roller defining a first central axis, a second pressing roller defining a second central axis, and a first rotating band, the first central axis and the second central axis arranged on a common horizontal plane and parallel to each other, the first rotating band wound around the first pressing roller and the second pressing roller, the first rotating band movable with rotation of the first pressing roller and the second pressing roller; and
a second pressing roller group being arranged below the first pressing roller group and spaced the predetermined distance from the first pressing roller group thereby defining a molding channel between the first pressing roller group and the second pressing roller group, the second pressing roller group comprising a third pressing roller defining a third central axis, a fourth pressing roller defining a fourth central axis, and a second rotating band, the third central axis and the fourth central axis being arranged on a common horizontal plane and parallel to each other, the second rotating band wound around the third pressing roller and the fourth pressing roller, the second rotating band movable with rotation of the third pressing roller and the fourth pressing roller;
wherein the melted resin from the feeding hopper flows into the guiding channel and is cooled and pressed by the platen and the first pressing roller group, and is then rolled into the molding channel with rolling of the first pressing roller group, and at least one of the first pressing roller group and the second pressing roller group is configured for forming microstructures on at least one corresponding surface of the cooled resin thereby forming the optical film.

2. The apparatus of claim 1, wherein the first rotating band comprises a first inner surface and a first outer surface, the first inner surface defines a plurality of first convex gear structures, and the first outer surface comprises a plurality of first microstructures thereon.

3. The apparatus of claim 2, wherein the second rotating band comprises a second inner surface and a second outer surface, the second inner surface defines a plurality of second convex gear structures, and the second outer surface is a smooth surface.

4. The apparatus of claim 1, wherein the second rotating band comprises a first inner surface and a first outer surface, the first inner surface defines a plurality of first convex gear structures, and the first outer surface defines a plurality of first microstructures thereon.

5. The apparatus of claim 4, wherein the first rotating band comprises a second inner surface and a second outer surface, the second inner surface defines a plurality of second convex gear structures, and the second outer surface is a smooth surface.

6. The apparatus of claim 5, wherein each of the first microstructures is substantially round, and each of the second microstructures is substantially V-shaped.

7. The apparatus of claim 3, wherein an outer circumferential surface of each of the first pressing roller and the second pressing roller defines a plurality of first concave gear structures matching with the first convex gear structures, and an outer circumferential surface of each of the third pressing roller and the fourth pressing roller defines a plurality of second concave gear structures matching with the second convex gear structures.

8. The apparatus of claim 1, wherein the first rotating band and the second rotating band are made of metal.

9. The apparatus of claim 3, wherein the first pressing roller group further comprises a first intermediate roller, the first intermediate roller is arranged between the first pressing roller and the second pressing roller, the first intermediate roller contacts the first inner surface of the first rotating band, and the first intermediate roller is capable of rotating about a central axis thereof and is configured for enhancing accurate formation of the pressed microstructures on the surface of the resin.

10. The apparatus of claim 9, wherein the second pressing roller group further comprises a second intermediate roller, the second intermediate roller is arranged between the third pressing roller and the fourth pressing roller, the second intermediate roller contacts the second inner surface of the second rotating band, and the second intermediate roller is capable of rotating about a central axis thereof and is configured for enhancing accurate formation of the pressed microstructures on the surface of the resin.

11. The apparatus of claim 1, further comprising a plurality of pinch rollers, wherein the pinch rollers are configured and arranged for preventing the optical film from warping.

12. The apparatus of claim 11, further comprising a winding roller, wherein the winding roller is configured for winding the optical film.

13. The apparatus of claim 12, wherein each of the platen, the first pressing roller, the second pressing roller, the third pressing roller and the fourth pressing roller comprises a plurality of cooling pipes around the central axis thereof.

14. An apparatus for manufacturing an optical film, the apparatus comprising:
a feed hopper comprising a pipe, the feed hopper configuring for providing resin in melted form to mold the optical film;
a platen, the platen comprising a smooth circumferential surface;
a first pressing roller group, the platen and the first pressing roller group both being arranged under the feeding hopper and spaced a predetermined distance from each other thereby defining a guiding channel between the platen and the first pressing roller group, the first pressing roller group comprising a first pressing roller, a second pressing roller, and a first rotating band, the first rotating band wound around the first pressing roller and the second pressing roller, the first rotating band movable with rotation of the first pressing roller and the second pressing roller; and
a second pressing roller group being arranged below the first pressing roller group and spaced the predetermined distance from the first pressing roller group thereby defining a molding channel between the first pressing roller group and the second pressing roller group, the second pressing roller group comprising a third pressing roller, a fourth pressing roller, and a second rotating band, the second rotating band wound around the third pressing roller and the fourth pressing roller, the second rotating band movable with rotation of the third pressing roller and the fourth pressing roller;
wherein the melted resin from the feeding hopper flows into the guiding channel and is cooled and pressed by the platen and the first pressing roller group, and is then rolled into the molding channel with rolling of the first pressing roller group, and at least one of the first pressing roller group and the second pressing roller group is configured for forming microstructures on at least one corresponding surface of the cooled resin thereby forming the optical film.

15. The apparatus of claim 14, wherein the first rotating band comprises a first inner surface and a first outer surface opposite to the first inner surface, the first inner surface defines a plurality of first convex gear structures, and the first outer surface comprises a plurality of first microstructures thereon.

16. The apparatus of claim 15, wherein the second rotating band comprises a second inner surface and a second outer surface opposite to the second inner surface, the second inner surface defines a plurality of second convex gear structures, and the second outer surface comprises a plurality of second microstructures thereon.

17. The apparatus of claim 16, wherein each of the first microstructures is substantially round, and each of the second microstructures is substantially V-shaped.

18. A method for manufacturing an optical film, the method comprising:
providing a feed hopper containing resin in melted form, a platen comprising a smooth circumferential surface, a first pressing roller group and a second pressing roller group, the platen and the first pressing roller group being arranged under the feeding hopper and spaced a predetermined distance from each other thereby defining a guiding channel between the platen and the first pressing roller group, the second pressing roller group being arranged below the first pressing roller group and spaced the predetermined distance from the first pressing roller group thereby defining a molding channel between the first pressing roller group and the second pressing roller group, the first pressing roller group comprising a first rotating band defining a plurality of first microstructures on a first outer circumferential surface thereof, the second pressing roller group comprising a second rotating band defining a plurality of second microstructures on a second outer circumferential surface thereof;
rotating the platen, the first pressing roller group, and the second pressing roller group, a rotating direction of the platen being reverse to that of the first pressing roller group, and the rotating direction of the first pressing roller group being reverse to that of the second pressing roller group; and
introducing melted resin from the feed hopper into the guiding channel, the platen and the first pressing roller group cooperatively cooling and pressing the melted resin, and rolling the cooled resin into the molding channel with rolling of the first pressing roller group, the first pressing roller group and the second pressing roller group forming microstructures on opposite surfaces of the cooled resin, respectively, thereby forming the optical film.

19. The method of claim 18, wherein the resin is selected from the group consisting of polystyrene, polymethyl methacrylate, polycarbonate and UV-curable glue.

20. The method of claim 18, further comprising:
winding up the optical film on a winding roller.
